(19) United States
(12) Patent Application Publication
(10) Pub. No.: US 2017/0158117 A1
(43) Pub. Date: Jun. 8, 2017

(54) Methods and Systems for Alerting Drivers of Hazards

(71) Applicant: DENSO International America, Inc., Southfield, MI (US)

(72) Inventors: Martin NESPOLO, Grosse Pointe Woods, MI (US); Yu ZHANG, Farmington Hills, MI (US); Thomas KRZYZAK, JR., Livonia, MI (US)

(21) Appl. No.: 14/962,727

(22) Filed: Dec. 8, 2015

(51) Int. Cl. B60Q 1/52; B60Q 1/46

(52) U.S. Cl. CPC B60Q 1/52; B60Q 1/46

(57) ABSTRACT

A system configured to alert drivers of hazards. The system includes at least one sensor of a subject vehicle that is configured to detect one or more hazards proximate to the subject vehicle. A hazard detection module is configured to identify hazards nearby the subject vehicle based on data collected by the at least one sensor. A warning device of the subject vehicle is configured to alert nearby secondary vehicles that the subject vehicle has identified a hazard.

### FIELD

The present disclosure relates to methods and systems for alerting drivers of hazards.

### BACKGROUND

This section provides background information related to the present disclosure, which is not necessarily prior art.

More and more vehicles are being equipped with advanced driver assistance systems (ADAS), which help drivers safely operate their vehicles. For example, ADAS systems are able to alert the driver of hazards to help the driver avoid a collision. While current ADAS systems are suitable for their intended use, they are subject to improvement. The present teachings provide improved methods and systems for alerting drivers of potential hazards, which address needs in the art and provide numerous advantages over current ADAS systems, as one skilled in the art will appreciate.

### SUMMARY

This section provides a general summary of the disclosure, and is not a comprehensive disclosure of its full scope or all of its features.

The present teachings provide for systems and methods configured to alert drivers of hazards. One exemplary system includes at least one sensor of a subject vehicle that is configured to detect one or more hazards proximate to the subject vehicle. A hazard detection module is configured to identify hazards nearby the subject vehicle based on data collected by the at least one sensor. A warning device of the subject vehicle is configured to alert nearby secondary vehicles that the subject vehicle has identified a hazard.

Further areas of applicability will become apparent from the description provided herein. The description and specific examples in this summary are intended for purposes of illustration only and are not intended to limit the scope of the present disclosure.

### DRAWINGS

The drawings described herein are for illustrative purposes only of selected embodiments and not all possible implementations, and are not intended to limit the scope of the present disclosure.

FIG. 1 illustrates a vehicle including a system according to the present teachings for alerting drivers of hazards;

FIG. 2 illustrates a method according to the present teachings for alerting drivers of hazards;

FIG. 3 illustrates, in accordance with the present teachings, the subject vehicle with its hazard lights activated in response to detection of a hazard by the subject vehicle, and a plurality of secondary vehicles with their hazards activated in response to a signal received from the primary vehicle so as to effectively extend the range of the warning issued by the subject vehicle; and

FIG. 4 illustrates an instrument cluster of the subject vehicle of FIG. 1 displaying an alert indicating that a warning device of the vehicle has been deployed in accordance with the present teachings.

Corresponding reference numerals indicate corresponding parts throughout the several views of the drawings.

### DETAILED DESCRIPTION

Example embodiments will now be described more fully with reference to the accompanying drawings.

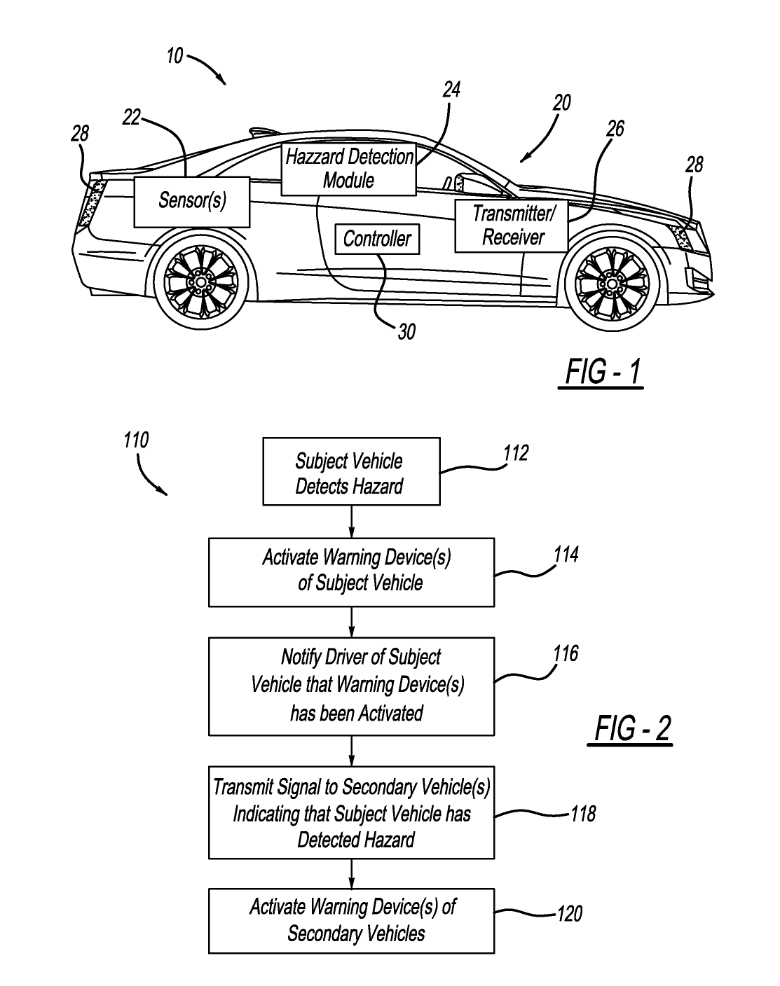

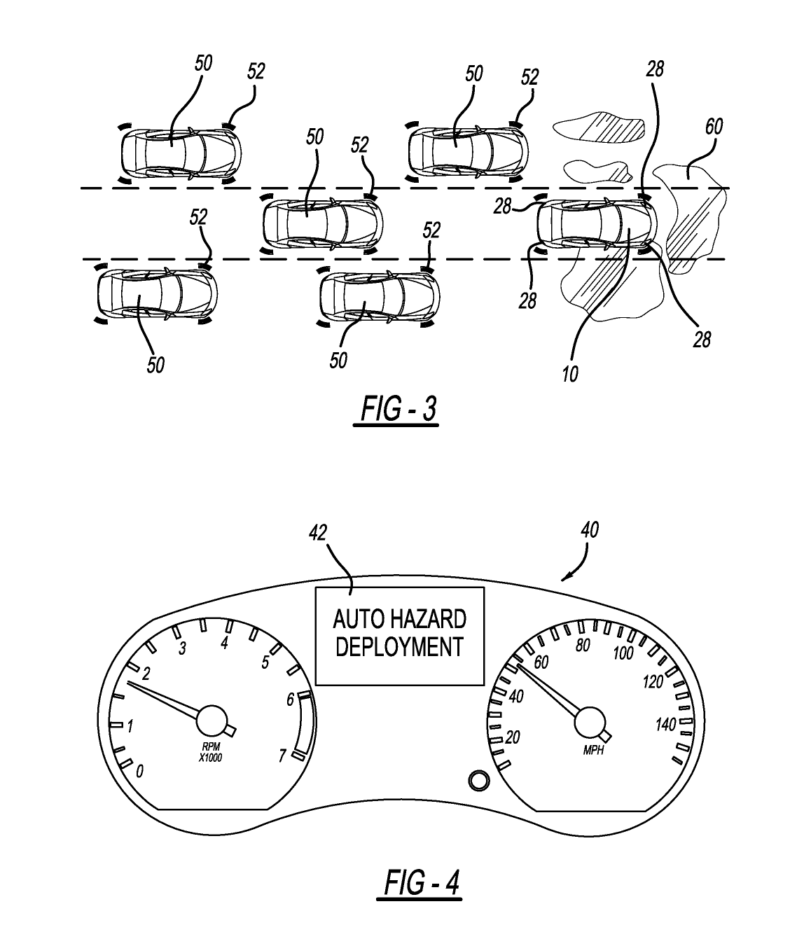

With initial reference to FIG. 1, a subject vehicle 10 is illustrated, which includes a system 20 according to the present teachings that is configured to alert drivers of hazards. The system 20 is configured to alert not only the driver of the subject vehicle 10, but also drivers of other vehicles (sometimes referred to herein as secondary vehicles and illustrated in FIG. 3 at reference numerals 50, for example). The system 20 generally includes one or more sensors 22, a hazard detection module 24, a transmitter and/or receiver 26, external warning devices 28 (such as the hazard lights of the subject vehicle 10, or any other suitable warning device(s)), and a controller 30. The system 20 can be configured for use with any suitable vehicle, such as a passenger car, sport utility vehicle, van, motorcycle, bus or other mass transit vehicle, a military vehicle, a construction vehicle, aircraft, watercraft, etc.

The sensors 22 can be any suitable sensors configured to detect hazards relative to the subject vehicle 10. The sensors 22 can thus include any suitable proximity sensors, object detection sensors, lane departure sensors, traffic sensors, and environmental condition sensors. For example, the sensors 22 can include at least one camera, radar, sonar, lidar, temperature sensor, pressure sensor, wind speed sensor, and/or an audio sensor, such as a microphone, configured to detect any suitable hazard proximate to the subject vehicle 10.

The sensors 22 can be configured to collect data that can be used to detect any type of hazard, such as other vehicles, pedestrians, animals, and/or hazardous road conditions, for example. To detect emergency or law enforcement vehicles, for example, the sensors 22 can be configured to identify warnings generated by the secondary vehicles, such as warnings in the form of hazard lights, emergency lights, and audible warnings (e.g., sirens). The sensors 22 can also be configured to identify hazardous road conditions, such as an icy road surface, high winds, an excessively wet road surface, or any other road condition resulting in a slippery road surface, which may result in reduced traction.

The hazard detection module 24 is configured to receive inputs from the sensors 22, and identify hazards based on the inputs from the sensors 22. The hazard detection module 24 may refer to, be part of, or include any suitable processor hardware (shared, dedicated, or group) that executes code, and memory hardware (shared, dedicated, or group) that stores code executed by the processor hardware. The code is configured to provide the features of the hazard detection module 24 described.

Based on the inputs from the sensors 22, the hazard detection module 24 is configured to identify any hazards proximate to the subject vehicle 10. For example, the hazard detection module 24 can be configured to identify one or more of the following: a secondary vehicle along a roadside; a disabled vehicle along the road or at any other relevant location; an emergency vehicle, such as an ambulance or fire truck; a law enforcement vehicle, such as a police car; any obstacle in the road or at any other relevant location, such as a fallen tree or rocks; an animal, such as a deer or kangaroo; and slippery road conditions that may cause the subject vehicle 10 or any other vehicle to experience reduced traction, such as icy road conditions.

The transmitter/receiver 26 can be any suitable transmitter and/or receiver configured to transmit/receive signals. For example, the transmitter/receiver 26 can be configured to receive radio frequency and/or GPS signals with data identifying one or more hazards, such as one or more of the following, for example: an accident, a traffic jam, dangerous road conditions, a disabled vehicle, a road obstruction, an emergency vehicle, a law enforcement vehicle, etc. The transmitter/receiver 26 can also be configured to transmit radio frequency signals (or any other types of signals) to vehicles proximate to the subject vehicle 10, or to any other receiver. For example, the transmitter/receiver 26 can be configured to transmit information regarding hazards detected by the hazard detection module 24. As a result, secondary vehicles can be informed of the hazards identified by the system 20 and can take action to avoid the hazards.

The warning device 28 can be any suitable warning device or system of the subject vehicle 10 configured to alert drivers of secondary vehicles nearby the subject vehicle 10 that the subject vehicle 10 has identified a hazard. As illustrated in the example of FIG. 1, the warning device 28 can include the external hazard lights of the subject vehicle 10. The warning device 28 can also include any other suitable visual warning of the subject vehicle 10, such as any other warning light of the subject vehicle 10. The warning device 28 can also include any suitable audible warning device, such as a horn, siren, or speaker configured to broadcast an audible alert from of the subject vehicle 10. The audible alert can include any suitable alert/warning, such as a semantic alert, a horn, or a speech tacton alert, which includes speech warnings combined with tactile driver alerts.

The controller 30 can be any suitable controller configured to control functionality of the system 20. For example, the controller 30 may refer to, be part of, or include processor hardware (shared, dedicated, or group) that executes code and memory hardware (shared, dedicated, or group) that stores code executed by the processor hardware. The code is configured to provide the features and functionality of the controller 30 and the system 20 described.

With continued reference to FIG. 1 and additional reference to FIG. 2, a method 110 according to the present teachings for alerting drivers of hazards will now be described. The method 110 detects hazards at block 112. Specifically, at block 112 the sensors 22 monitor the area around the subject vehicle 10 and input the data gathered by the sensors 22 to the hazard detection module 24. The hazard detection module 24 processes the data from the sensors 22 to determine whether there are any hazards nearby. For example, the hazard detection module 24 can determine one or more of the following: whether there is a secondary vehicle nearby the subject vehicle 10 that may pose a collision hazard, such as a disabled vehicle in the road or a vehicle along a side of the road; whether an emergency or law enforcement vehicle is nearby; whether an obstacle is in the road ahead of the subject vehicle 10, such as trees, rocks, or debris; whether an animal is in the road or nearby; and/or whether dangerous road condition are present, such as whether the road is icy or otherwise slick.

When the hazard detection module 24 identifies a hazard, the method 110 proceeds to block 114, where the controller 30 activates the warning device 28 of the subject vehicle. The warning device 28 will thus advantageously notify drivers of surrounding secondary vehicles that a hazard has been identified by the subject vehicle 10. For example and as illustrated in FIG. 3, upon detection of hazard 60, such as ice in the road, the hazard lights 28 of the subject vehicle 10 are activated, thereby informing drivers of secondary vehicles 50 that the subject vehicle 10 has detected a hazard 60. Thus, drivers of the secondary vehicles 50 will be on notice of the hazard, thereby allowing the drivers of the secondary vehicles 50 to take appropriate action even though the secondary vehicles 50 may not be equipped with an ADAS system.

At block 116, the controller 30 generates a notification to the driver of the subject vehicle 10 to inform him/her that the hazard detection module 24 has detected a hazard and that the warning devices 28 of the subject vehicle 10 have been activated. This makes it clear to the driver of the subject vehicle 10 why the warning device 28 thereof has been activated. Any suitable notification to the driver can be generated. For example and as illustrated in FIG. 4, at an instrument cluster 40 of the subject vehicle 10, a display 42 can display any suitable message to the driver, such as “Auto Hazard Deployment.” The display 42 can also include any suitable information regarding the hazard, such as the type of hazard, location of the hazard, etc.

At block 118 of the method 110, the system 20 can optionally use the transmitter/receiver 26 to transmit a signal to the secondary vehicles 50 to notify any suitable system thereof that the subject vehicle 10 has detected a hazard. The signal transmitted can be any suitable radio frequency signal, optical signal, or audible signal, for example. The secondary vehicles 50 can include any suitable receiver for receiving the notification signal from the subject vehicle 10. For example, if the notification signal is a radio frequency signal, the receiver of the secondary vehicles 50 can be any suitable radio frequency receiver. If the notification signal is an optical signal, the receiver can be an optical receiver. The optical receiver can be configured to detect any optical signal generated at the subject vehicle 10, such as the flashing hazards of the warning device 28. In response to receipt of the notification signal from the subject vehicle 10, systems of the secondary vehicles 50 can activate any suitable warning devices of their own, such as hazards 52 of the secondary vehicles 50. In this manner, the hazard detection of the subject vehicle 10 is effectively relayed to surrounding vehicles in order to inform drivers thereof that a hazard is nearby.

Example embodiments are provided so that this disclosure will be thorough, and will fully convey the scope to those who are skilled in the art. Numerous specific details are set forth such as examples of specific components, devices, and methods, to provide a thorough understanding of embodiments of the present disclosure. It will be apparent to those skilled in the art that specific details need not be employed, that example embodiments may be embodied in many different forms and that neither should be construed to limit the scope of the disclosure. In some example embodiments, well-known processes, well-known device structures, and well-known technologies are not described in detail.

The terminology used is for the purpose of describing particular example embodiments only and is not intended to be limiting. The singular forms “a,” “an,” and “the” may be intended to include the plural forms as well, unless the context clearly indicates otherwise. The terms “comprises,” “comprising,” “including,” and “having,” are inclusive and therefore specify the presence of stated features, integers, steps, operations, elements, and/or components, but do not preclude the presence or addition of one or more other features, integers, steps, operations, elements, components, and/or groups thereof. The method steps, processes, and operations described herein are not to be construed as necessarily requiring their performance in the particular order discussed or illustrated, unless specifically identified as an order of performance. It is also to be understood that additional or alternative steps may be employed.

When an element or layer is referred to as being “on,” “engaged to,” “connected to,” or “coupled to” another element or layer, it may be directly on, engaged, connected or coupled to the other element or layer, or intervening elements or layers may be present. In contrast, when an element is referred to as being “directly on,” “directly engaged to,” “directly connected to,” or “directly coupled to” another element or layer, there may be no intervening elements or layers present. Other words used to describe the relationship between elements should be interpreted in a like fashion (e.g., “between” versus “directly between,” “adjacent” versus “directly adjacent,” etc.). The term “and/or” includes any and all combinations of one or more of the associated listed items.

Although the terms first, second, third, etc. may be used to describe various elements, components, regions, layers and/or sections, these elements, components, regions, layers and/or sections should not be limited by these terms. These terms may be only used to distinguish one element, component, region, layer or section from another region, layer or section. Terms such as “first,” “second,” and other numerical terms when used do not imply a sequence or order unless clearly indicated by the context. Thus, a first element, component, region, layer or section discussed below could be termed a second element, component, region, layer or section without departing from the teachings of the example embodiments.

Spatially relative terms, such as “inner,” “outer,” “beneath,” “below,” “lower,” “above,” “upper,” and the like, may be used for ease of description to describe one element or feature's relationship to another element(s) or feature(s) as illustrated in the figures. Spatially relative terms may be intended to encompass different orientations of the device in use or operation in addition to the orientation depicted in the figures. For example, if the device in the figures is turned over, elements described as “below” or “beneath” other elements or features would then be oriented “above” the other elements or features. Thus, the example term “below” can encompass both an orientation of above and below. The device may be otherwise oriented (rotated 90 degrees or at other orientations) and the spatially relative descriptors used herein interpreted accordingly.

The foregoing description of the embodiments has been provided for purposes of illustration and description. It is not intended to be exhaustive or to limit the disclosure. Individual elements or features of a particular embodiment are generally not limited to that particular embodiment, but, where applicable, are interchangeable and can be used in a selected embodiment, even if not specifically shown or described. The same may also be varied in many ways. Such variations are not to be regarded as a departure from the disclosure, and all such modifications are intended to be included within the scope of the disclosure.

What is claimed is:

1. A system configured to alert drivers of hazards comprising:
at least one sensor of a subject vehicle configured to detect one or more hazards proximate to the subject vehicle;
a hazard detection module configured to identify hazards nearby the subject vehicle based on data collected by the at least one sensor; and
a warning device of the subject vehicle configured to alert nearby secondary vehicles that the subject vehicle has identified a hazard.

2. The system of claim 1, wherein:
the at least one sensor includes at least one of a camera, radar, sonar, lidar, temperature sensor, pressure sensor, wind speed sensor, and audio sensor.

3. The system of claim 1, wherein:
the at least one sensor is configured to detect at least one of the following: the subject vehicle's proximity to the hazard, lane position of the subject vehicle, traffic conditions, road conditions, and weather.

4. The system of claim 1, wherein the at least one sensor includes at least one of a lane departure detection sensor, a proximity sensor, an object detection sensor, and an environmental sensor.

5. The system of claim 1, wherein the at least one sensor is configured to detect at least one of the following: vehicles, including law enforcement and emergency vehicles; pedestrians; animals; and road conditions.

6. The system of claim 1, wherein the at least one sensor of the subject vehicle is configured to identify a warning generated by a secondary vehicle, the warning including hazard lights, emergency lights, and an audible warning including a siren.

7. The system of claim 1, wherein the hazard detection module is configured to identify one or more of the following hazards: a secondary vehicle along a roadside; a disabled vehicle; an emergency vehicle; a law enforcement vehicle; an obstacle; an animal; and slippery road conditions.

8. The system of claim 1, wherein the warning device includes at least one of a visual warning and an audible warning.

9. The system of claim 8, wherein the visual warning includes hazard lights.

10. The system of claim 8, wherein the audible warning includes at least one of a semantic alert, a horn, and a speech tacton alert.

11. The system of claim 1, further comprising a receiver for the subject vehicle configured to receive a transmission identifying a hazard;
wherein the transmission identifies at least one of the following: an accident; a traffic jam; dangerous road conditions; a disabled vehicle; a road obstruction; an emergency vehicle; a law enforcement vehicle; and a hazard detected by one or more nearby secondary vehicles.

12. The system of claim 1, further comprising a transmitter configured to transmit to secondary vehicles information regarding a hazard identified by the hazard detection module.

13. The system of claim 1, further comprising a notification device configured to notify the driver of the subject vehicle that the warning device has been activated by a controller of the system in response to identification of a hazard by the hazard detection module.

14. A method for alerting drivers of hazards comprising:
detecting a hazard with a hazard detection module of a subject vehicle based on data from at least one sensor of the subject vehicle, the at least one sensor configured to detect one or more hazards proximate to the subject vehicle; and
activating a warning device of the subject vehicle configured to alert nearby secondary vehicles that the subject vehicle has identified a hazard, upon detection of the hazard by the hazard detection module.

15. The method of claim 14, further comprising detecting at least one of the following with the at least one sensor: the subject vehicle's proximity to the hazard; lane position of the subject vehicle; traffic conditions; and environmental conditions including road conditions; and
wherein the at least one sensor includes at least one of a camera, radar, sonar, and lidar.

16. The method of claim 14, further comprising detecting one or more of the following hazards with the hazard detection module: a secondary vehicle along a roadside; a disabled vehicle; an emergency vehicle; a law enforcement vehicle; an obstacle; an animal; and slippery road conditions.

17. The method of claim 14, wherein activating the warning device includes activating at least one of a visual warning and an audible warning, the visual warning includes hazard lights of the subject vehicle.

18. The method of claim 14, further comprising receiving with a receiver of the subject vehicle a transmission identifying a hazard;
wherein the transmission identifies at least one of the following: an accident; a traffic jam; dangerous road conditions; a disabled vehicle; a road obstruction; an emergency vehicle; a law enforcement vehicle; and a hazard detected by one or more nearby secondary vehicles.

19. The method of claim 14, further comprising transmitting from the subject vehicle to secondary vehicles information regarding a hazard identified by the hazard detection module.

20. The method of claim 19, wherein warning devices of the secondary vehicles are activated in response to receipt by the secondary vehicles of the information regarding the hazard identified by the hazard detection module of the subject vehicle.
